(19) United States
(12) Patent Application Publication
(10) Pub. No.: US 2023/0405806 A1
(43) Pub. Date: Dec. 21, 2023

(54) Self-Contained Actuator for An Industrial Robot

(71) Applicant: ABB Schweiz AG, Baden (CH)

(72) Inventors: Shanghua Li, Västerås (SE); Liming Liu, Cary, NC (US); Damian Kowal, Västerås (SE); Tomas Botold, Västerås (SE); Bin Liu, Västerås (SE); Zach Pan, Cary, NC (US); Rajib Mikail, Raleigh, NC (US); Yang Gao, Västerås (SE)

(21) Appl. No.: 18/251,318

(22) PCT Filed: Feb. 4, 2021
(86) PCT No.: PCT/EP2021/052631

§ 371 Date: May 1, 2023

Related U.S. Application Data
(60) Provisional application No. 63/111,523, filed on Nov. 9, 2020.

(51) Int. Cl. B25J 9/10

(52) U.S. Cl. CPC B25J 9/104

(57) ABSTRACT

A self-contained actuator for use in a robot manipulator includes: a housing, in which are arranged in axial sequence a gear, a motor, a brake, a sensor and a motor drive. The motor drive includes wide-bandgap/WBG electronics and is arranged in heat-dissipating relationship with a free end of the housing. Through the motor and some further components, there is provided a central channel for receiving a cable connected to at least one further actuator of the robot manipulator. The channel may be angled or straight. In embodiments where the motor drive is hollow, the central channel extends between the axial ends of the actuator. There is further provided an all-in-one industrial robot comprising a robot manipulator, in which one or more self-contained actuators with the above characteristics are installed and a robot controller is physically integrated.

### TECHNICAL FIELD

The present disclosure relates to the field of industrial robotics and in particular to an actuator for a robot manipulator.

### BACKGROUND

Robot arm segments and other mechanical parts of robot manipulators are connected by joints that allow linear or rotary motion along respective axes. At such joints, actuators including electric motors are installed to apply accelerating, braking and/or turning forces between pairs of robot parts. The actuators may further be adapted to power an end effector carried by the robot manipulator. The de facto standard setup is to provide each robot manipulator with an independent robot controller, which is responsible not only for control and monitoring in the strict sense but also operates power conversion circuitry which transforms electric grid power into AC or DC signals that suit each of the installed motors.

FIG. 1 is a simplified illustration of this state-of-the-art topology, where the industrial robot 100 generally consists of a robot controller 140 connected to an electricity grid 150 and a robot manipulator 110 configured to handle or process a payload (workpiece) 190. The robot manipulator 110 has a plurality of actuators 120′, each including a motor M (e.g., servo motor) and gear G for transferring the motor torque to a shaft or other output element. The robot controller 140 includes a main computer C, motor drive circuitry D and a central power module P. The main computer C controls movements and other behaviour of the robot manipulator 110 in accordance with a system configuration, which may comprise user-defined project data and project-independent software. The power module P performs rectification, power-factor correction and various further aspects of preconditioning of the incoming voltage from the grid 150 to feed the motor drive circuitry D. The power module P may also be configured to feed regenerated braking energy back to the grid iso. A drive signal generated by the motor drive circuitry D is supplied to the corresponding actuator 120′ over a respective cable bundle (or cable harness) 130′. The cable bundle 130′ may further comprise a bidirectional analog or digital connection to the main computer C for control and monitoring purposes.

As FIG. 1 shows, the state-of-the-art topology involves a considerable amount of duplication at the level of the cabling, with several parallel segments that add to the bulkiness and exposure to wear. If the cables are routed on the exterior of the robot manipulator 110, they may as well pose hygienic risks. More recently, several lighter industry branches (food and beverage; computer, communication and consumer electronics, ‘3C’) are moving towards simplicity, reduced cost and footprint. This evolution works in favor of integrated robot controllers in which, conceptually, some components of the robot controller 140 have been decentralized and moved to the robot manipulator 110.

One of the aimed-for designs within this class of robots is shown in FIG. 2, where the robot manipulator 110 is powered by self-contained actuators 120, and the motor drive circuitry D is co-located with the motor M. If the integration of the components of the actuators 120 is practically feasible, the cabling can be reduced very significantly as regards the number of cables and their total length, possibly down to a common bus 130 providing electric power and data connectivity, such as EtherCAT™ or Ethernet™. The functional components of the central robot controller 140 may be reduced to the power module P and the main computer C.

Self-contained actuators 120 of the desirable type shown in FIG. 2 have not yet been reduced to practice on commercially competitive terms. This problem has spurred the present disclosure.

### SUMMARY

One objective is to make available a self-contained actuator suitable for a robot manipulator. It is a particular objective to provide the necessary cooling in such an actuator. It is a particular objective to ensure reasonable ease of cable routing in a robot comprising multiple actuators. It is a further particular objective to ensure the space efficiency of the actuator, and also limit its weight and bulkiness.

These and other objectives are achieved by a self-contained actuator with the technical features according to claim 1. The dependent claims define advantageous embodiments of the actuator.

In one aspect, a self-contained actuator for a robot manipulator comprises a housing with a free end, which normally faces away from the closest parts of robot manipulator where it is installed. The actuator further comprises a motor and a motor drive and optional further components. The motor drive and motor are arranged in axial sequence, and the motor drive may be in heat-dissipating relationship with the free end. The motor drive may in particular be arranged axially closer to the free end than the motor. The further components, if any, may be one or more of a brake, a gear and a sensor. According to one embodiment, the motor drive includes wide-bandgap (WBG) electronics. Additionally, there is a central channel passing through the motor and the optional further components which is suitable for receiving a cable.

The above objectives are adequately addressed by this embodiment and renders the actuator truly self-contained. Put differently, the actuator represents an all-in-one solution which can be connected to a generic electric power source and suitable control signals. The successful integration of the components is owed, on the one hand, to the ability of the WBG electronics to withstand a higher working temperature than conventional Si-based circuitry, so that a passive thermal conduction or convection provide adequate cooling. WBG electronics also have a higher power-to-volume ratio and suffer less thermal stress during operation. On the other hand, while some volume inside the actuator is devoted to the central channel, the resulting passage facilitates robust internal cable routing and makes the actuator fit to be installed in a robot manipulator where a common cable or common bus serves multiple actuators.

A further aspect of the invention relates to a robot manipulator comprising a plurality of self-contained actuators with the above characteristics and a cable serving said actuators and that passes through the central channel of at least the inner (proximal) ones of the actuators. The robot manipulator may have a snake-shape design. The robot manipulator is preferably in the relatively smaller size range, with an end-effector speed of at most 10 m/s (such as at most 7 m/s) and a payload of at most 100 kg (such as at most 10 kg). The robot manipulator may be adapted for common tasks in light industry, such as 3C or food and beverage. Further, the robot manipulator may be a part of a collaborative robot designed for training and/or productive cooperation close to a human operator at little or no risk of physical injury. The robot manipulator may be combined with a robot controller to form a complete industrial robot.

As used herein, a “gear” refers to a mechanical component or system for transmitting motor torque to a rotary or linearly movable output element of the actuator. A gear in this sense may include a gear train with one or more wheels engaging directly or via chains or belts.

A “free end” may refer to a portion which is surrounded by an ambient medium in a manner to allow cooling. Alternatively or additionally, it may refer to a portion not intended to be mounted inside another element.

As used herein, the “axial” direction of an actuator may correspond to the symmetry axis of the components, the orientation of the central channel, a torque vector produced by the motor and/or a longitudinal axis of a cylinder defining an overall shape of the actuator.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, on which:

FIG. 1 shows an industrial robot according to a centralized topology, where a power module and motor drive circuitry are located in the robot controller;

FIG. 2 shows an industrial robot according to a distributed topology (partially integrated robot controller), where the motor drive circuitry is co-located with the respective motors in the robot manipulator and the power module is contained in the robot controller;

FIG. 3 is a perspective view of a self-contained actuator according to one embodiment;

FIG. 4 is an axial section through a self-contained actuator with an angled cable channel according to one embodiment;

FIG. 5 is an axial section through a self-contained actuator with a straight central cable channel according to one embodiment; and

FIG. 6 is a side view of a robot manipulator.

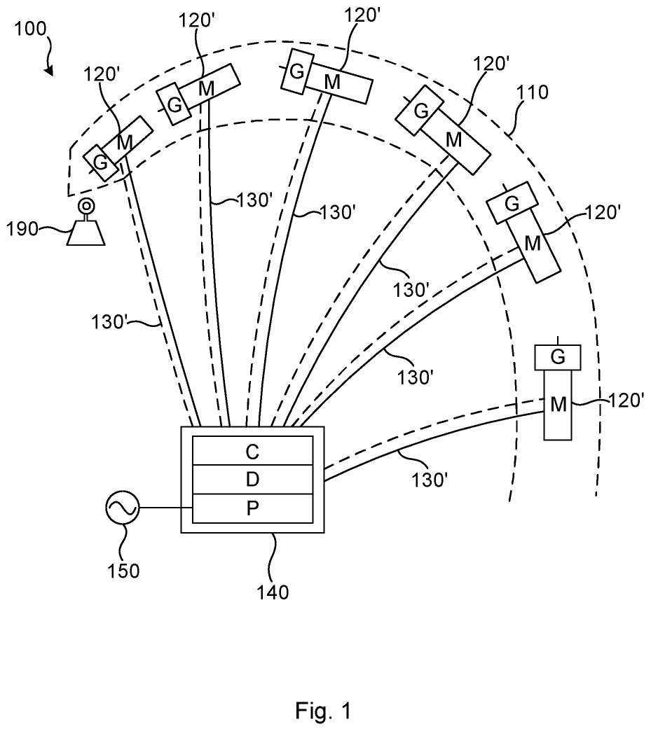

### DETAILED DESCRIPTION

Certain embodiments of the invention will now be described more fully with reference to the accompanying drawings. Since the invention may be embodied in many different forms, these embodiments should not be construed as limiting but rather as examples included to render this disclosure thorough and complete, and to fully convey the scope of all aspects of invention to those skilled in the art. Like numbers refer to like elements throughout the description.

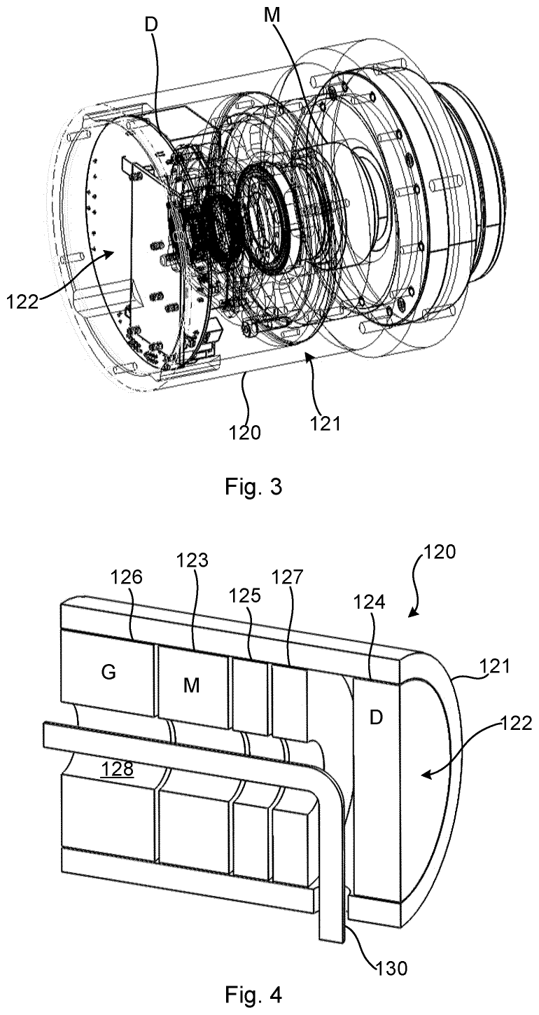

FIG. 3 shows a self-contained actuator 120 according to an embodiment. The actuator 121 has a substantially cylinder-shaped housing 121 accommodating a motor M that is supplied with electric power from a connected motor drive D. The motor M is operable to apply a positive or negative torque acting between the housing 121 and an output shaft extending from the right axial end of the housing. The motor M may be a hollow conventional electric motor or a hollow frameless electric motor. In a frameless motor, the outer perimeter of the stator is in direct contact with the housing 121. The stator may be attached to the lateral portion of the housing 121 in a torsionally rigid fashion. The motor M may be designed to be cooled, at least in part, by natural convection from the stator through the lateral portion of the housing 121 to a frame or surface of the robot manipulator 110.

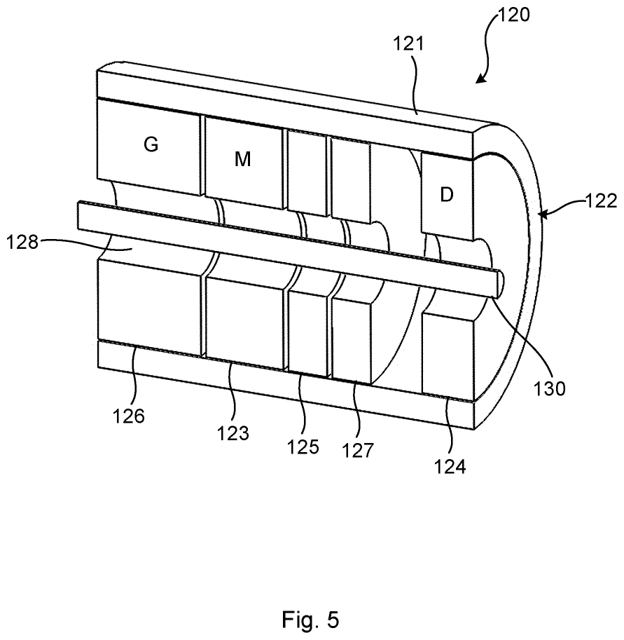

The housing's 121 left axial end may constitute a free end 122 suitable for dissipating excess heat. From the point of view of cooling, it is of advantage that the motor drive D is located close to the free end 122, or otherwise in good heat-dissipating relationship with the free end 122 thanks to dedicated heat-conducting structures (e.g., solid elements, greasing with thermal paste). While not explicitly shown in FIG. 3, the actuator 120 may comprise further components, such as a brake, a gear, sensors, as described below with reference to FIGS. 4 and 5. The further components may also include decentralized parts of the robot controller, including processing circuitry configured to assist in the control and monitoring of the actuator 120. Another way to ensure good heat dissipation from the motor drive D via the free end 122 is to arrange the motor drive D axially closer to the free end 122 than the motor M and any of said further components of the actuator 120.

The motor drive D of the actuator 120 comprises power electronics for converting an input power into a drive signal suitable for an electric motor. The input power may be drawn from a direct-current (DC) bus in the robot manipulator 110 nominally delivering a standardized voltage, such as 48 V, or a dedicated internal bus voltage of several hundreds of volts, such as 200 V, 300 V, 600 V or more. The drive signal is typically a rapidly varying alternating-current (AC) signal with controllable amplitude, phase and frequency. The switching frequency (or fundamental frequency) may be of the order of kilohertz, such as 8 kHz or even 16 kHz, 32 kHz, 50 kHz or more in the case of a frameless motor M. At frequencies of this order of magnitude, the current ripple, torque ripple and losses in the motor M are limited. The use of the high switching frequencies is rendered possible, in part, by the closeness of the motor drive D and the motor M, whereby the impact of parasitic impedances in cables is limited. The power electronics in the motor drive D include or are based on one or more WBG materials, such as silicon carbide SiC, or any of the nitrides AlN, GaN and BN. These materials are generally characterized by high power efficiency, high ratio of power to volume, they undergo low thermal stress while in operation and remain operable at relatively high temperature. These characteristics make the motor drive D suitable for integration with the actuator 120. WBG electronics may alternatively be referred to as WBG semiconductor components.

An optional functionality of the motor drive D is to regenerate braking energy at times when the motor M is operated in generator mode, to absorb kinetic energy from moving robot parts. The resulting electric power may be output to the DC bus for the benefit of further actuators 120 in the robot manipulator 110. Alternatively, excess bus power may be converted to grid frequency and voltage by the power module P and fed back to the public grid 150.

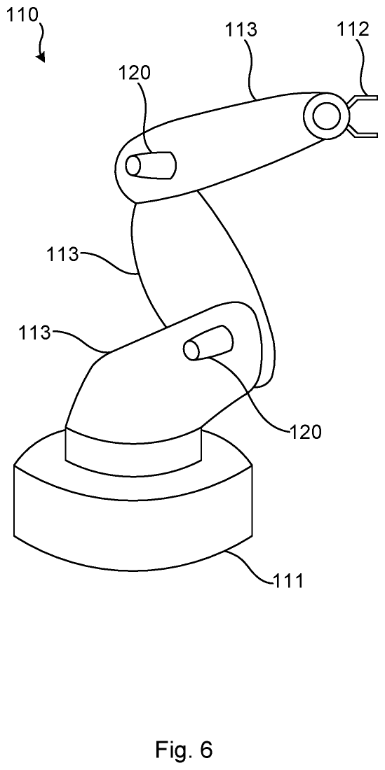

FIG. 6 illustrates an example way of installing a self-contained actuator 120 like the one in FIG. 3 in a robot manipulator 110. In the shown robot manipulator no, an innermost (proximal) segment 113 extends from a base 111, is connected by a rotary joint to a middle segment 113, which is in turn connected by a further rotary joint to the outermost (distal) segment 113, which carries an end effector 112. The end effector 112 may be mounted on a robot wrist (not shown). A reference point on the end effector 112 is commonly referred to as the tool center point (TCP). The end effector 112 is configured to handle a workpiece with a specified maximum payload and at specified maximum TCP speed.

The robot manipulator 110 is shown equipped with two actuators 120, a lower one for applying a torque between the innermost and middle segments 113 and an upper one for applying a torque between the middle and outermost segments 113. The robot manipulator 110 may further comprise an actuator 120 arranged to power the end effector 112. Each actuator 120 is mounted in a position slightly recessed into the respective segment 113, so that the free end 122 projects outwardly and is surrounded by the ambient medium in a manner favoring efficient heat dissipation. In use cases, it is not uncommon for the interior of a robot manipulator 110 to have a temperature several tens of degrees higher than the ambient air. The housing 121 of the actuator 120 may locally constitute a portion of the robot manipulator's no housing; then, the effective heat sink surface can be extended by providing good thermal contact between the housing 121 and a surrounding edge of the manipulator's no housing. In addition to cooling, the positioning of the motor drive D near the free end 122 also serves to limit the influence of mechanical vibrations and electromagnetic interference from the motor M. The actuator's 120 drive shaft end, at its right-hand side in FIG. 3, is oriented inwardly and is mechanically connected to a movable part of the robot manipulator 110. The connection may be either direct or indirect via gears, dampers, self-locking friction brakes or similar elements.

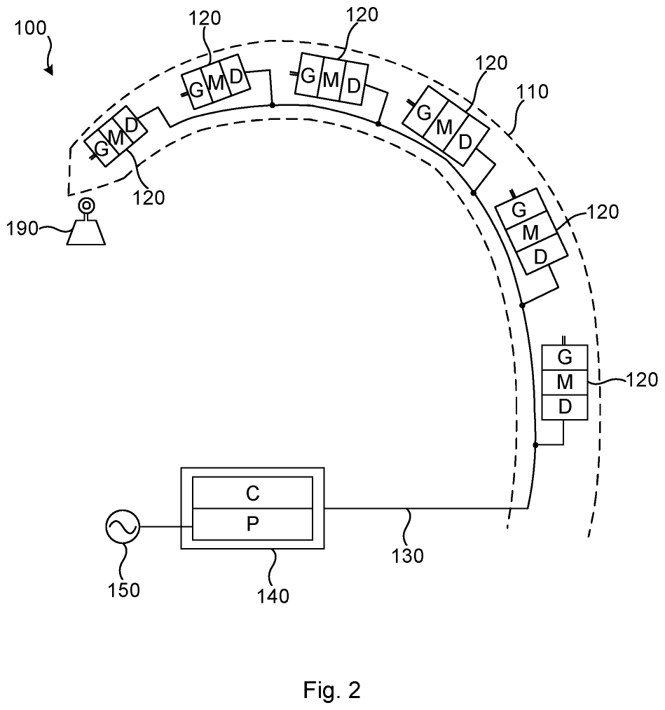

The manipulator base 111 (or foot) shown in FIG. 6 may accommodate a robot controller 140 according to FIG. 2, that is, with a power module P and main computer C. Without departing from the scope of the invention, some capabilities of the robot controller 140 may be implemented in a distributed fashion, e.g., they may be delegated to an edge controller, cloud server or other networked processing resources. Even though a longer latency may be expected when control signals travel over a network, at least during network fluctuations (e.g., jitter), the negative effects of such delays may be purposefully avoided by implementing machine-level control, safety monitoring and other delay-sensitive functionalities in circuitry that is integrated in the actuator 120.

FIG. 4 is an axial section through a self-contained actuator 120 according to one embodiment. Compared to the level of constructive detail in FIG. 3, the representation in FIG. 4 is simplified to put emphasis on the relative positions of the components of the actuator 120. More precisely, FIG. 4 shows, in axial sequence from left to right, several hollow components, an empty segment at the level of a lateral hole through the housing 121, and a non-hollow motor drive 124 at the free end 122 of the housing 120. The hollow components, the empty segment and the lateral hole together form an angled channel 128, in which a bus or cable 130 may be installed. The cable 130 may continue to at least one further actuator 120 installed in the robot manipulator. The left side of the housing 121 may be closed and define a central hole, or the left side may be open. The angled shape of the channel 128 is advantageous if the actuator 120 is to be mounted in a recessed position with respect to the manipulator 110 surface, like in FIG. 6. More precisely, if the lateral hole and the portion to the left thereof are inside the robot manipulator 110, the full length of the cable 130 is protected while the free end 122 remains in contact with the ambient medium and can dissipate excess heat efficiently.

The hollow components at the left end of the actuator 120 may include a gear 126, a motor 123, a brake 125 and at least one sensor 127. The sensor 127 may be a linear or angular position sensor or a strain sensor. Additional sensors (not shown) may be provided to allow measurements on both the low-speed and the high-speed side of the gear 126. Thus, the motor 123 is arranged axially between the motor drive 124 and the gear 126. The motor 123 may be adjacent to the gear 126 to simplify the mechanical connection. The motor drive 124 is axially closer to the free end 122 of the housing than the motor 123. It is also axially closer to the free end 122 than any of the further components.

In variations of this embodiment, the actuator 120 may comprise additional non-hollow components which are arranged next to the motor drive 124.

FIG. 5 shows a self-contained actuator 120 according to a further embodiment. The drawing conventions and reference numbers are consistent with those used in FIG. 4. The motor 123 remains in a position axially between the motor drive 122 and the gear 126. The motor drive 124 is axially closer to the free end 122 than the motor 123. It is also axially closer to the free end 122 than any of the further components. Here, to illustrate one of several possible options, the gear 126 is positioned next to the motor 123.

The embodiment of FIG. 5 differs from that of FIG. 4 in that all components of the actuator 120 are hollow and thereby define a straight channel 128 extending between a left axial end of the housing 121 and a right axial end of the housing 121. The straight channel 128 allows a cable 130 to pass without being urged into a sharp bend. The output torque of the motor 123 may act between movable (rotatable) segments of the housing 121, between the housing 121 and a lateral shaft (not shown), or between the housing 121 and a hollow shaft (not shown) through which the cable 130 may leave the housing 121.

In FIG. 5, there is an axial gap between the sensor 127 and motor drive 124. This serves to decouple the motor drive 124 thermally and/or mechanically from the other components inside the housing 121, to reduce the impact of conductive heating and propagating vibrations. In variations of this embodiment, the gap may be replaced by a thermal barrier, such as a hollow heat insulator or a hollow vibration damper. Alternatively, the housing 121 is divided into two axial portions by an interposed thermal barrier, such as a polymer ring. In still further variations, where neither heating nor vibrations are significant concerns, the sensor 127 and motor drive 124 may be arranged next to each other.

With reference to FIG. 2, it was explained above how the operation of a robot manipulator 110 may be supported by a robot controller 140. This discussion is valid equivalently for robot manipulators 110 equipped with actuators 120 according the embodiments described herein. FIG. 2 shows an embodiment where some functions of a conventional robot controller are executed by components of the actuators 120, e.g., the motor drive D. This may be regarded as a partial physical integration of the robot controller into the robot manipulator 110. Yet certain control and supply functions may remain with the robot controller 140. The splitting of the control functions into a delay-sensitive local part and a higher-level cloud or edge-server part has been mentioned as one example. As to the supply function, the robot controller 140 may administer electric power, pressurized fluids, a flow of paint or other material to be applied to a workpiece and connectivity to an external network.

The invention further includes a further development of the partially integrated embodiment in FIG. 2 into an all-in-one industrial robot 100, where the robot controller 140 is (completely) physically integrated into the robot manipulator no. For example, the robot controller 140 may be contained in a base 111 of the robot manipulator 110. The integrated robot controller 140 may include WBG electronics, as discussed next.

The robot controller 140 may act as an interface between a public power grid 150 and electric loads connected to a bus 130 in the robot manipulator 110. In this role, a power module P within the robot controller 140 may be configured to perform one or more of: conversion between AC and DC, frequency stabilization, voltage stabilization (optionally including feeding excess power back to the grid 150), power factor control, time- or frequency-domain filtering, interruption protection. These operations may optionally be performed using closed-loop control with the waveform of the bus 130 or grid 150 as feedback signals. In contrast to this, the motor drive D in each actuator 120 may generate the drive signal to the motor M only on the basis of control signals and observed motor conditions. This is to say, in normal working conditions it treats the bus 130 as an ideal voltage source with infinite internal resistance. The power module P may include conventional Si-based power electronics or WBG electronics. The use of WBG electronics may favor volume and weight efficiency of the robot controller 140, relax cooling requirements and reduce the total footprint of the industrial robot 100. It is therefore especially advantageous to use WBG electronics if the robot controller 140 is physically integrated into the robot manipulator 110.

Still with reference to FIG. 2, it is noted that the embodiments described herein make available a cable channel 128 through the full axial length of each actuator 120 (straight channel 128, FIG. 5) or a portion of the actuator 120 (angled channel 128, FIG. 4), and thereby simplifies the routing of the bus 130. In FIG. 2, therefore, the illustrated bus 13o, which has been drawn schematically in a position next to the actuators 120, may correspond to a physical bus 130 that actually passes through some of the actuators 120. Such internal cable routing is particularly advantageous in an actuator 120 equipped with a frameless motor M, whose stator is in direct contact with the housing 121, which may in turn be adjacent to the surface of the robot manipulator 110. Since the bus 130 may be led through the central channel, the actuator 120 can be fitted to the inside of the robot manipulator 110 snugly and in a uniform manner over its full circumference.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A self-contained actuator for a robot manipulator, the actuator comprising:
a housing with a free end;
a motor; and
a motor drive including wide-bandgap electronics, which motor drive is arranged in heat-dissipating relationship with the free end of the housing and axially closer to the same than the motor,
wherein the motor drive and the motor are arranged in axial sequence and at least the motor defines a central channel for receiving a cable.

2. The actuator of claim 1, further comprising a gear, wherein:
the motor is arranged axially between the motor drive and the gear; and
at least the gar and the motor define the central channel.

3. The actuator of claim 2, further comprising further components, such as a brake and a sensor, arranged axially between the motor drive and the gear, wherein at least the motor and said further components define the central channel.

4. The actuator of claim 1, wherein the motor drive, motor and further components define the central channel, which extends axially through the actuator.

5. The actuator of claim 3, wherein the motor drive is arranged axially closer to the free end of the housing than any of the further components.

6. The actuator of claim 1, wherein the motor is a frameless electric motor.

7. The actuator of claim 1, wherein the motor drive is operable to regenerate braking energy.

8. The actuator of claim 1, wherein the motor drive is adopted for a switching frequency of at least 15 kHz and/or a DC voltage of at least 200 V.

9. The actuator of claim 1, wherein the central channel is suitable for receiving a cable connected to at least one further actuator of the robot manipulator.

10. A robot manipulator comprising:
a plurality of self-contained actuators each having a housing with a free end;
a motor; and
a motor drive including wide-bandgap electronics which motor drive is arranged in heat-dissipating relationship with the free end of the housing and axially closer to the same than the motor,
wherein the motor drive and the motor are arranged in axial sequence and at least the motor defines a central channel for receiving a cable; and
a cable serving said actuators and passing through the central channel of at least one of the actuators.

11. The robot manipulator of claim 10, which is adopted for an end-elector speed of at most 10 m/s and/or for an end-elector payload of at most 100 kg.

12. A industrial robot comprising a robot manipulator having a plurality of self-contained actuators each having a housing with a free end:
a motor; and
a motor drive including wide-bandgap electronics, which motor drive is arranged in heat-dissipating relationship with the free end of the housing and axially closer to the same than the motor,
wherein the motor drive and the motor are arranged in axial sequence and at least the motor defines a central channel for receiving a cable; and
a cable serving said actuators and passing through the central channel of at least one of the actuators.

12. The industrial robot of claim 12, further comprising a robot controller which is integrated or partially integrated into the robot manipulator.

13. The industrial robot of claim 13, wherein the robot controller is integrated into the robot manipulator and included wide-bandgap power electronics.
